(19) United States
(12) Patent Application Publication
(10) Pub. No.: US 2025/0096683 A1
(43) Pub. Date: Mar. 20, 2025

(54) POWER CONVERSION CIRCUIT

(71) Applicant: ROHM CO., LTD., Kyoto-shi (JP)

(72) Inventor: Shinji YATO, Kyoto-shi (JP)

(21) Appl. No.: 18/883,617

(22) Filed: Sep. 12, 2024

(30) Foreign Application Priority Data
Sep. 14, 2023 (JP) 2023-149487

(51) Int. Cl. H02M 3/158; H02M 1/08; H02M 7/5387

(52) U.S. Cl. CPC H02M 3/158; H02M 1/08; H02M 7/5387

(57) ABSTRACT

In a power conversion circuit, a first end of an inductor is connected to a connection point between a first and a second switching elements. The first switching element is turned on and turned off by a gate driver. When the first switching element is turned on, a conduction current flows through the inductor and energy is stored. When the first switching element is turned off, due to release of the energy, a rectified current is generated through the second switching element. A loop of a gate current supplied by the gate driver is formed inside a loop of the rectified current. A magnetic flux that is in an opposite direction of a magnetic flux of the rectified current and is generated in the loop of the gate current generates an induced current in a direction opposite to the gate current, and charges accumulated in a gate are drawn out.

### CROSS-REFERENCE TO RELATED APPLICATIONS

The present application is based on, and claims priority to, Japanese Patent Application No. 2023-149487 filed on Sep. 14, 2023, the entire contents of which are incorporated herein by reference.

### TECHNICAL FIELD

The present disclosure relates to a power conversion circuit.

### BACKGROUND

A power conversion circuit in which an inductor is connected to a connection point between a high-side switching element and a low-side switching element which are connected in series with each other and perform complementary switching operations, is used for various applications. Examples thereof include a power supply circuit for converting power of a DC power supply into desired power, a drive circuit for driving a load as an inverter, and the like. In the various applications, it is necessary to increase switching speed in order to perform smaller and more efficient power conversion. A MOSFET (Metal-Oxide-Semiconductor Field Effect Transistor), an IGBT (Insulated Gate Bipolar transistor), and the like are often used for a switching element. An insulating gate of the switching element is voltage-driven by a gate driver.

To increase the switching speed of the switching element, it is known that an MOSFET for drawing out base charges is disposed to a bipolar transistor which is actually connected between both terminals of a DC power supply and performs complementary switching operations. By rapidly drawing out accumulated charges of the base with the MOSFET, the speed of a turn-off operation is increased.

### BRIEF DESCRIPTION OF THE DRAWINGS

FIG. 1 is an electric circuit diagram of a power conversion circuit according to a first embodiment.

FIG. 2 is a schematic waveform diagram illustrating how currents flowing through an inductor are changed by a switching element performing switching in the power conversion circuit illustrated in FIG. 1.

FIG. 3 is a schematic waveform diagram illustrating an enlarged switching portion in a time axis in the waveform diagram of FIG. 2.

FIG. 4 is a circuit diagram illustrating an extracted portion of the power conversion circuit illustrated in FIG. 1 in a form closer to a substrate mounting state.

FIG. 5 is a waveform diagram illustrating a result of an experiment performed by the inventor of the present application.

FIG. 6 is an electric circuit diagram of a power conversion circuit according to a second embodiment.

FIG. 7 is a circuit diagram illustrating an extracted portion of the power conversion circuit illustrated in FIG. 6 in a form closer to a substrate mounting state.

FIG. 8 is an electric circuit diagram of a power conversion circuit according to a third embodiment.

FIG. 9 is a circuit diagram illustrating an extracted portion of the power conversion circuit illustrated in FIG. 8 in a form closer to a substrate mounting state.

FIG. 10 is a circuit diagram illustrating an extracted portion of a power conversion circuit according to a fourth embodiment in a form closer to a substrate mounting state.

### DETAILED DESCRIPTION

Next, various embodiments will be described with reference to the drawings. In the description of the drawings below, the same or similar parts are denoted with the same or similar reference signs. However, it should be noted that the drawings such as electric circuit diagrams are schematically illustrated and they are different from those in reality. Further, the following embodiments exemplify an apparatus and a method for embodying a technical concept, and do not specify the material, shape, structure, arrangement, and the like of each component. Various modifications may be made to the embodiments within the scope of claims.

### First Embodiment

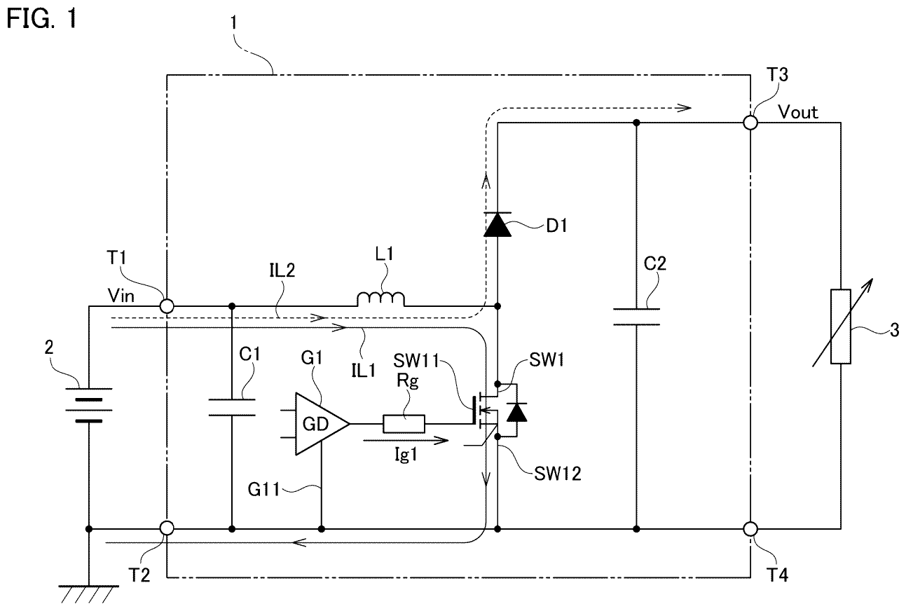

FIG. 1 is an electric circuit diagram of a power conversion circuit 1 according to a first embodiment. The power conversion circuit 1 is a half-bridge non-isolated boost converter. The power conversion circuit 1 includes smoothing capacitors C1, C2, switching elements D1, SW1, an inductor L1, a gate driver G1, and a gate resistor Rg. Due to the power conversion circuit 1 being a boost converter, the high-side switching element D1 and the low-side switching element SW1, which are connected in series with each other and perform complementary switching operations, are connected between output terminals T3, T4. A first end of the inductor L1 is connected to a connection point between the switching elements D1, SW1. An input voltage Vin from a DC power supply 2 is input to the smoothing capacitor C1 from power supply input terminals T1, T2 and is smoothed. A high-side terminal of the smoothing capacitor C1 is connected to a second end of the inductor L1. The smoothing capacitor C2 is interposed between the output terminals T3, T4, and an output voltage Vout is applied to a load 3. The GND-side power supply input terminal T2 is connected to an output terminal T4.

In an example of FIG. 1, the high-side switching element D1 is a diode, and the low-side switching element SW1 is a MOSFET. An insulating gate SW11 of the switching element SW1 is voltage-driven by the gate driver G1. The gate driver G1 supplies a gate current Ig1 to the insulating gate SW11 with the gate resistor Rg therebetween, to accumulate charges in the insulating gate SW11, and if a gate voltage is equal to or more than a predetermined threshold voltage due to the accumulation of charges, the switching element SW1 is turned on. Alternatively, if the accumulated charges in the gate SW11 are lost due to the gate driver G1 stopping the supply of the gate current Ig1, and if a gate voltage is less than the predetermined threshold voltage, the switching element SW1 is turned off. A MOSFET may be used for the switching element D1 in the case of synchronous rectification. Each switching element SW1, D1 may be an IGBT having a reverse conducting diode. Due to the power conversion circuit 1 being a boost converter, Vin<Vout holds, and the diode serving as the switching element D1 has an anode on the connection point side and a cathode on the output terminal T3 side, and receives and flows out a rectified current IL2 from the inductor L1 described later.

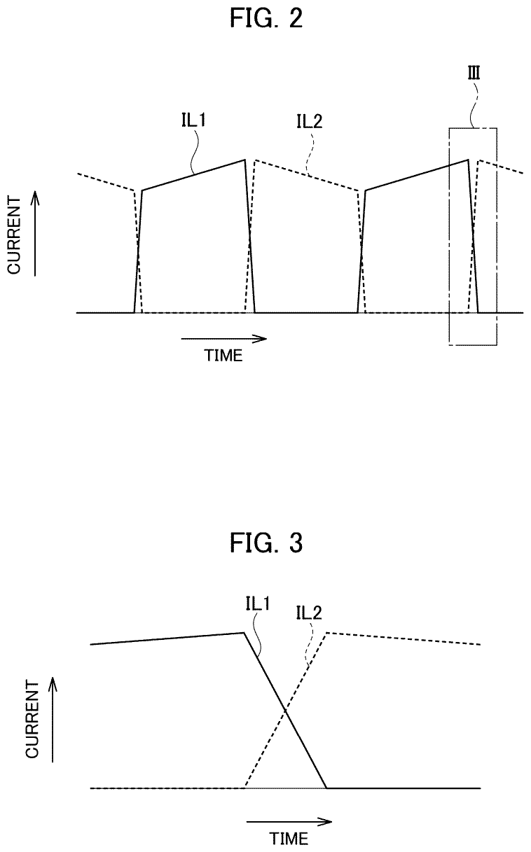

When the switching element SW1 in the power conversion circuit 1 described above is turned on, a conduction current IL1 illustrated with a solid line flows along a path (loop) of a positive electrode of the DC power supply 2, the inductor L1, the low-side switching element SW1, and a negative electrode of the DC power supply 2, and energy is stored in the inductor L1. At this time, if Vin<Vout holds, the high-side switching element D1 is turned off. Meanwhile, when the switching element SW1 is turned off, an operation of the inductor L1 is switched from energy storage to energy release, and accordingly the high-side switching element D1 is turned on. As a result, the rectified current IL2 illustrated with a broken line flows along a path (loop) of the inductor L1, the high-side switching element D1, the smoothing capacitor C2 and the load 3, the negative electrode of the DC power supply 2, the positive electrode of the DC power supply 2, and the inductor L1. FIG. 2 schematically illustrated how the conduction current IL1 illustrated with a solid line and the rectified current IL2 illustrated with a broken line are switched. Further, FIG. 3 is an enlarged view of a portion denoted with reference sign III in FIG. 2 where the conduction current IL1 is switched to the rectified current IL2 in a time axis.

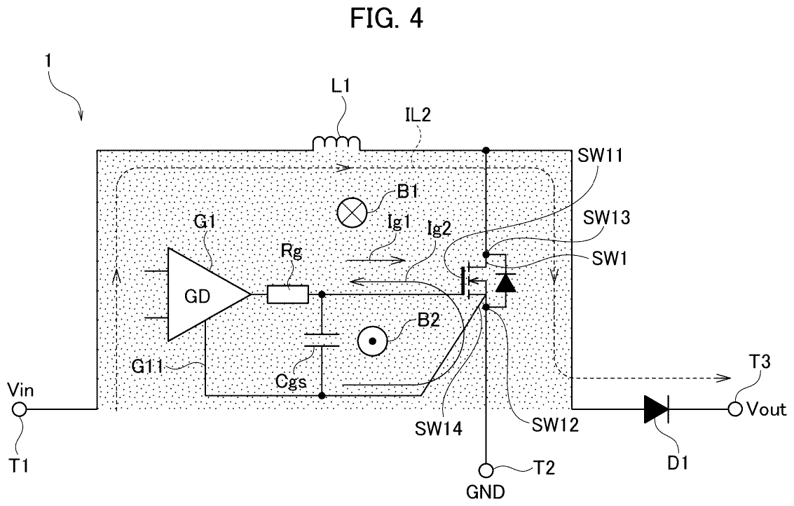

In the power conversion circuit 1 configured as above of the first embodiment, a special current loop is formed to draw out the accumulated charges in the insulating gate SW11 when the switching element SW1 is turned off. FIG. 4 is a circuit diagram illustrating an extracted portion of the power conversion circuit 1 schematically illustrated in FIG. 1 in a form closer to a substrate mounting state. Portions in FIG. 4 corresponding to those in FIG. 1 are denoted with the same reference signs. In the power conversion circuit 1 of the first embodiment, a current of a predetermined level (such as a certain degree of load being driven) flows in the path (loop) of the conduction current IL1 and the path (loop) of the rectified current IL2. For example, a current of several tens to several hundreds A (amperes) is used. Magnetic fluxes are generated around wiring of the paths (loops) according to Fleming's right-hand rule. In the first embodiment, a magnetic flux of the rectified current IL2 is used.

Specifically, the rectified current IL2 illustrated with a broken line flows along a path (loop) of the inductor L1, the high-side switching element D1, the smoothing capacitor C2 and the load 3, the negative electrode of the DC power supply 2, the positive electrode of the DC power supply 2, and the inductor L1. However, in FIG. 4, the current flows in an approximately clockwise direction along a path (loop) of an input terminal T1, the inductor L1, the high-side switching element D1, and the output terminal T3 which are extracted. As a result, in FIG. 4, according to the Fleming's right-hand rule, a magnetic flux B1 is generated inside the path (loop) illustrated with hatching, the magnetic flux B1 being perpendicular to the page space and extending from a front (near) side to a back (far) side of the page space.

Therefore, in the first embodiment, a path (loop) of an induced current Ig2 flowing in a direction opposite to the gate current Ig1 is formed inside the path (loop) of the rectified current IL2. Specifically, the induced current Ig2 flows along a path (loop) of a return line G11 of the gate driver G1, a source SW12 of the switching element SW1, the insulating gate SW11, the gate resistor Rg, and the gate driver G1. Therefore, a current in a direction opposite to the gate current Ig1 is generated in the loop of the induced current Ig2 in order to generate a magnetic flux B2 in an opposite direction so as to cancel the magnetic flux B1 generated by the loop of the rectified current IL2, that is, in order to generate the magnetic flux B2 extending from the back (far) side to the front (near) side of the page space.

Therefore, the charges accumulated in the insulating gate SW11 by the gate current Ig1 flowing through the insulating gate SW11 to turn on the switching element SW1 are drawn out by the induced current Ig2 flowing from the source SW12 to the insulating gate SW11, when the switching element is turned off. Therefore, the power conversion circuit 1 of the first embodiment can increase the speed of a turn-off operation and reduce the switching loss by improving the circuit arrangement without having a separate configuration.

However, even though the path (loop) of the induced current Ig2 described above is formed, it is difficult for the induced current Ig2 to flow in a path opposite to the path of the gate current Ig1. Therefore, a capacitor Cgs is disposed for high-frequency connection between the source SW12 of the switching element SW1 and an output terminal of the gate driver G1. The capacitor Cgs is instantaneously short-circuited when the switching element SW1 is turned off, and the induced current Ig2 can be increased. This can draw out the charges accumulated in the insulating gate SW11 rapidly, and increase the speed of a turn-off operation.

In the first embodiment, a SiC (silicon carbide) MOSFET having a driver source (Kelvin source) terminal SW14 is used for the switching element SW1. Then, the gate coupling capacitance between the driver source terminal SW14 and the insulating gate SW11 functions as the capacitor Cgs, short-circuiting in terms of high frequencies is performed between the terminals (SW14 and SW11) when the induced current Ig2 rises, and accordingly the path (loop) of the induced current Ig2 is formed.

By using an element with the driver source terminal SW14 as the switching element SW1, the path (loop) of the induced current Ig2 by short-circuiting in the capacitor Cgs is already formed. Therefore, by simply forming the path (loop) of the rectified current IL2 so as to surround the switching element SW1 without providing any special components, it is possible to draw out the accumulated charges in the gate SW11 rapidly, and increase the speed of a turn-off operation.

In a switching element such as an MOSFET and an IGBT, it is conceivable to reduce a resistance value of the gate resistor Rg that controls the gate current Ig1 from the gate driver G1 to allow charges to accumulate rapidly and to increase a switching speed. In this case, the switching speed is increased by increasing the speed of a turn-on operation. However, when the resistance of the gate resistor Rg is made small, a gate-source voltage Vgs does not drop during a turn-off operation, and there is a risk of a false firing. Further, voltage surge of a drain-source voltage Vds increases, and this causes a risk of element breakage. Although it is possible to respond to the false firing by providing an active mirror clamp circuit or the like, it is also necessary to provide new components, and this increases the cost and complicates a circuit.

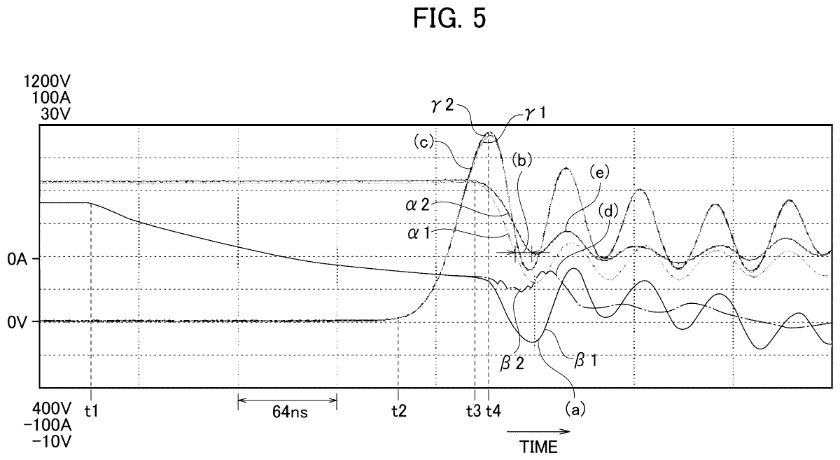

FIG. 5 is a waveform diagram illustrating a result of an experiment performed by the inventor of the present application. In the experiment, a SiCMOSFET having the driver source terminal SW14 is used as the switching element SW1. In FIG. 5, reference signs a1 and a2 indicate the conduction current IL1. Reference sign a1 indicates an experimental result of the first embodiment in which the path (loop) of the rectified current IL2 is formed so as to surround the switching element SW1. Reference sign a2 indicates a reference example in which no special improvement is made for the path of the rectified current IL2. Similarly, reference signs β1 and β2 indicate a voltage Vgs between the insulating gate SW11 and the source SW12, reference sign β1 indicates the first embodiment, and reference sign β2 indicates the reference example. Further, similarly reference signs γ1 and γ2 indicate a voltage Vds between a drain SW13 and the source SW12, reference sign γ1 indicates the first embodiment, and reference sign γ2 indicates the reference example.

In FIG. 5, a horizontal axis indicates a time, and one division is 64 ns. A vertical axis indicates a current or a voltage, and one division is 25 A for the conduction current IL1 denoted with reference signs α1 and α2, 5 V for the gate-source voltage Vgs denoted with reference signs β1 and β2, and 200 V for the drain-source voltage Vds denoted with reference signs γ1 and γ2. Therefore, in FIG. 5, the upper limit of the vertical axis is 1200 V for the drain-source voltage Vds, 30 V for the gate-source voltage Vgs, and 100 A for the conduction current IL1. The lower limit of the vertical axis is −400 V for the drain-source voltage Vds, −10 V for the gate-source voltage Vgs, and −100 A for the conduction current IL1.

A switching frequency in the experiment in FIG. 5 is substantially 0 Hz. At time t1, when the gate driver G1 stops (OFF) the injection of the gate current Ig1, the gate-source voltage Vgs denoted with reference signs β1 and β2 starts to gradually decrease from about 18 V. Then, the drain-source voltage Vds denoted with reference signs γ1 and γ2, which was 0 V due to the switching element SW1 being turned on, starts to increase from a time around time t2. From a time around time t3, ampere of the conduction current IL1 denoted with reference signs α1 and a2 starts to decrease from about 60 A. The switching element D1 is turned on, and the rectified current IL2 starts to flow.

At time t4, when the gate-source voltage Vgs denoted with reference signs β1 and β2 becomes less than 7 V, which is an ON threshold value of the switching element SW1, the switching element SW1 is turned off. At a time around time t4, surge of the drain-source voltage Vds denoted with reference signs γ1 and γ2 reaches a peak, as illustrated by reference sign (c).

However, when the rectified current IL2 starts to flow from a time around time t3, in the first embodiment, the induced current Ig2 flows, and due to charges accumulated in the gate being drawn out, the gate-source voltage Vgs denoted with reference sign β1 rapidly decreases as illustrated by reference sign (a). Therefore, the conduction current IL1 denoted with reference sign α1 also starts to decrease rapidly. Meanwhile, in the reference example, the conduction current IL1 denoted with reference sign α2 decreases, that is, the turn-off of the switching element SW1 is slow, and the conduction current IL1 flows for a longer time than the conduction current IL1 denoted with reference sign α1 of the first embodiment by the amount indicated by reference sign (b). Therefore, it is understood that in the first embodiment, the switching loss can be reduced by the amount indicated by reference sign (b).

In addition, although the gate-source voltage Vgs denoted with reference sign β2 in the reference example has little ringing caused by parasitic L and C components, it takes time for the voltage to drop to 0 V, and at the first ringing illustrated by reference sign (d), the voltage becomes equal to or more than the above-mentioned threshold voltage, and the false firing occurs. Therefore, the conduction current IL1 denoted with reference sign α2 rises again as illustrated by reference sign (e), and the switching loss is further deteriorated. Therefore, in the reference example, the above-mentioned mirror clamp circuit is required in order to suppress the power loss caused by the false firing. Meanwhile, although the gate-source voltage Vgs denoted with reference sign β1 in the first embodiment has some ringing, since the voltage approaches 0 V, no false firing occurs, therefore the mirror clamp circuit is not required, and there is no power loss caused by the false firing.

As described above, in the power conversion circuit 1 of the first embodiment, the path (loop) of the induced current Ig2 is formed inside the path (loop) of the rectified current IL2 flowing at the time of switching OFF. Charges accumulated in the gate are drawn out with the induced current Ig2 generated by the magnetic fluxes B1 and β2 coupling between them. Therefore, it is not necessary for the power conversion circuit 1 of the first embodiment to have a separate configuration such as a mirror clamp circuit, and by improving the circuit arrangement, it is possible to increase the speed of a turn-off operation and reduce the switching loss. In addition, since it is not necessary to reduce the gate resistor Rg, the drain-source voltage Vds denoted with reference signs γ1 and γ2 in FIG. 5 remains almost unchanged and undesirable element breakage is not caused.

### Second Embodiment

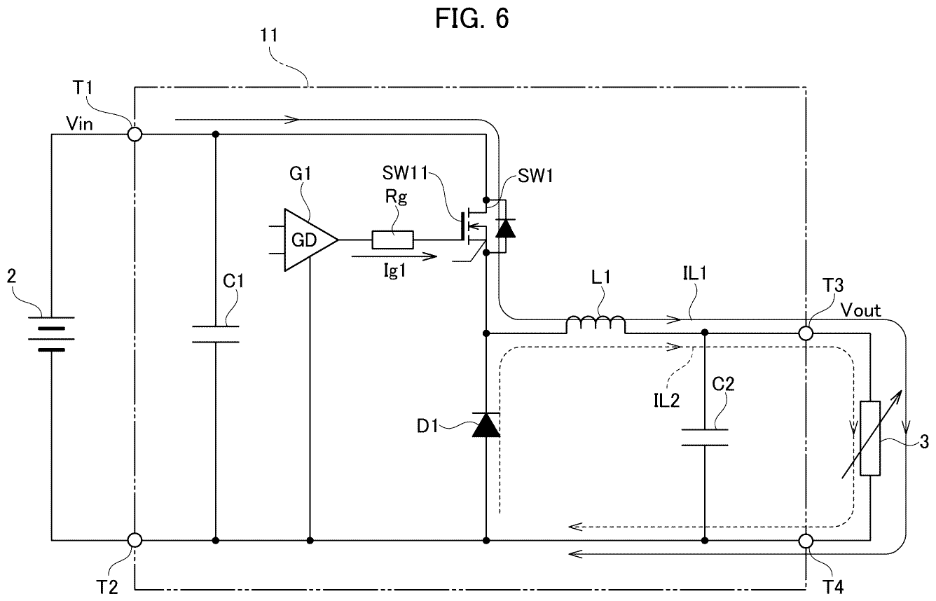

FIG. 6 is an electric circuit diagram of a power conversion circuit 11 according to a second embodiment. The power conversion circuit 11 is a half-bridge non-isolated buck converter. The power conversion circuit 11 is similar to the power conversion circuit 1 described above, and portions of the power conversion circuit 11 corresponding to those in the power conversion circuit 1 are denoted with the same reference signs as in the power conversion circuit 1. The power conversion circuit 11 includes smoothing capacitors C1, C2, switching elements D1, SW1, an inductor L1, a gate driver G1, and a gate resistor Rg. Due to the power conversion circuit 11 being the buck converter, an input voltage Vin from a DC power supply 2 is input from power supply input terminals T1, T2, via the smoothing capacitor C1, to the high-side switching element SW1 and the low-side switching element D1, which are connected in series with each other and perform complementary switching operations. A first end of the inductor L1 is connected to a connection point between the switching elements SW1, D1, and a second end of the inductor L1 is connected to a high-side output terminal T3. The smoothing capacitor C2 is interposed between the high-side output terminal T3 and a low-side output terminal T4, and an output voltage Vout is applied to a load 3.

In an example of FIG. 6, the high-side switching element SW1 is an MOSFET, and the low-side switching element D1 is a diode. An MOSFET may be used for the switching element D1 in the case of synchronous rectification. Each switching element SW1, D1 may be an IGBT having a reverse conducting diode. Due to the power conversion circuit being a buck converter, Vin>Vout holds, and a diode serving as the switching element D1 has a cathode on the connection point side and an anode on the output terminal T4 (GND) side, and allows a rectified current IL2 returning to the inductor L1 described later to pass therethrough.

When the switching element SW1 is turned on, a conduction current IL1 illustrated with a solid line flows along a path (loop) of a positive electrode of the DC power supply 2, the high-side switching element SW1, the inductor L1, the smoothing capacitor C2 and the load 3, and a negative electrode of the DC power supply 2, and energy is stored in the inductor L1. At this time, if a cathode potential>an anode potential holds, the low-side switching element D1 is turned off. Meanwhile, when the switching element SW1 is turned off, an operation of the inductor L1 is switched from energy storage to energy release, and accordingly the low-side switching element D1 is turned on. As a result, the rectified current IL2 illustrated with a broken line flows along a path (loop) of the inductor L1, the smoothing capacitor C2 and the load 3, the low-side switching element D1, and the inductor L1. FIG. 2 described above also schematically illustrates how the conduction current IL1 and the rectified current IL2 are switched.

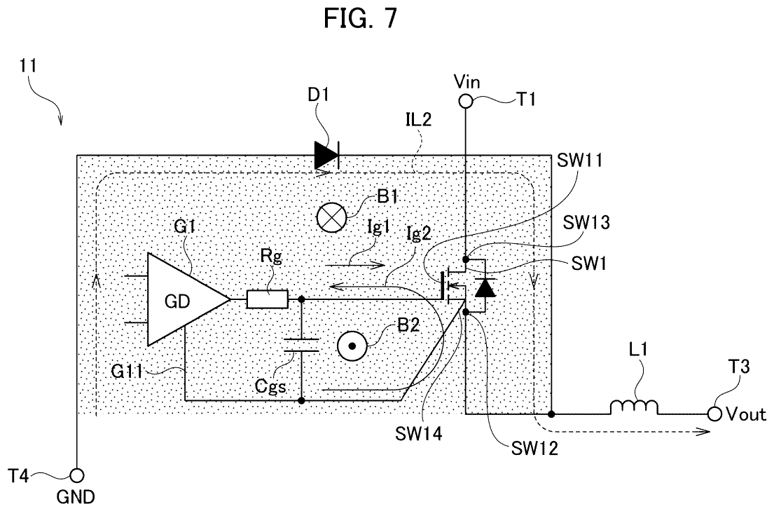

FIG. 7 is a circuit diagram illustrating an extracted portion of the power conversion circuit 11 schematically illustrated in FIG. 6 in a form closer to a substrate mounting state as in FIG. 4. Portions in FIG. 7 corresponding to those in FIG. 6 are denoted with the same reference signs. In the power conversion circuit 11 configured as above of the second embodiment, a special current loop is formed to draw out charges accumulated in an insulating gate SW11 when the switching element SW1 is turned off.

Specifically, the rectified current IL2 illustrated with a broken line flows along a path (loop) of the inductor L1, the smoothing capacitor C2 and the load 3, the low-side switching element D1, and the inductor L1. However, in FIG. 7, the current flows in an approximately clockwise direction along a path (loop) of the output (GND) terminal T4, the low-side switching element D1, the inductor L1, and the high-side output terminal T3 which are extracted. As a result, in FIG. 7, according to the Fleming's right-hand rule, a magnetic flux B1 is generated inside the path (loop) illustrated with hatching, the magnetic flux B1 being perpendicular to the page space and extending from a front (near) side to a back (far) side of the page space.

Therefore, in the second embodiment, a path (loop) of an induced current Ig2 flowing in a direction opposite to a gate current Ig1 is formed inside the path (loop) of the rectified current IL2. More specifically, as described above, an MOSFET having a driver source terminal SW14 is used for the switching element SW1, the gate coupling capacitance between the driver source terminal SW14 and the insulating gate SW11 functions as a capacitor Cgs, and the path (loop) of the induced current Ig2 is formed. Therefore, a current in a direction opposite to the gate current Ig1 is generated in the loop of the induced current Ig2 in order to generate a magnetic flux B2 in an opposite direction of the magnetic flux B1 generated by the loop of the rectified current IL2, that is, in order to generate the magnetic flux B2 extending from the back (far) side to the front (near) side of the page space.

Therefore, charges accumulated in the insulating gate SW11 by the gate current Ig1 flowing through the insulating gate SW11 to turn on the switching element SW1 are drawn out by the induced current Ig2 flowing from the driver source terminal SW14 to the gate SW11, when the switching element is turned off. Therefore, even in the non-isolated buck converter, it is possible to realize the power conversion circuit which can increase the speed of a turn-off operation and reduce the switching loss by improving the circuit arrangement without having a separate configuration such as a mirror clamp circuit.

### Third Embodiment

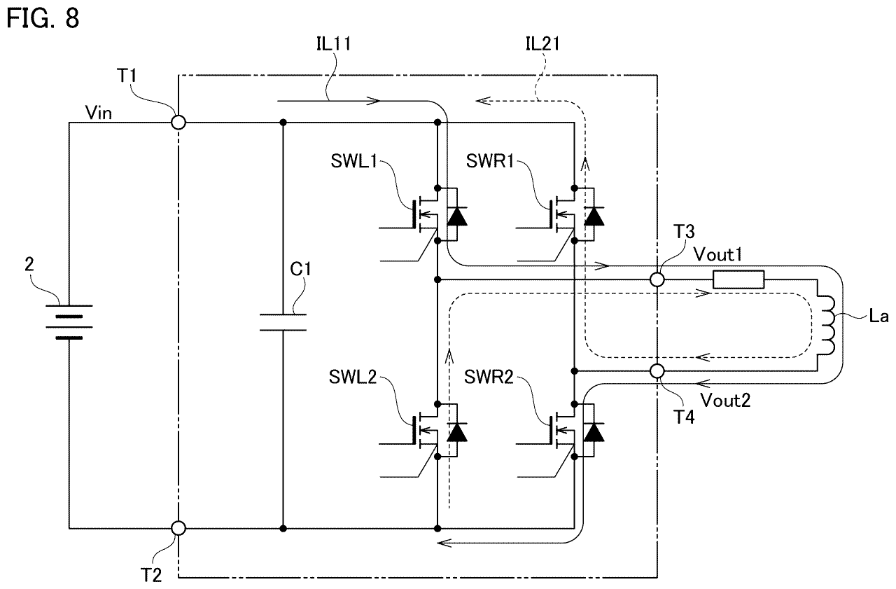

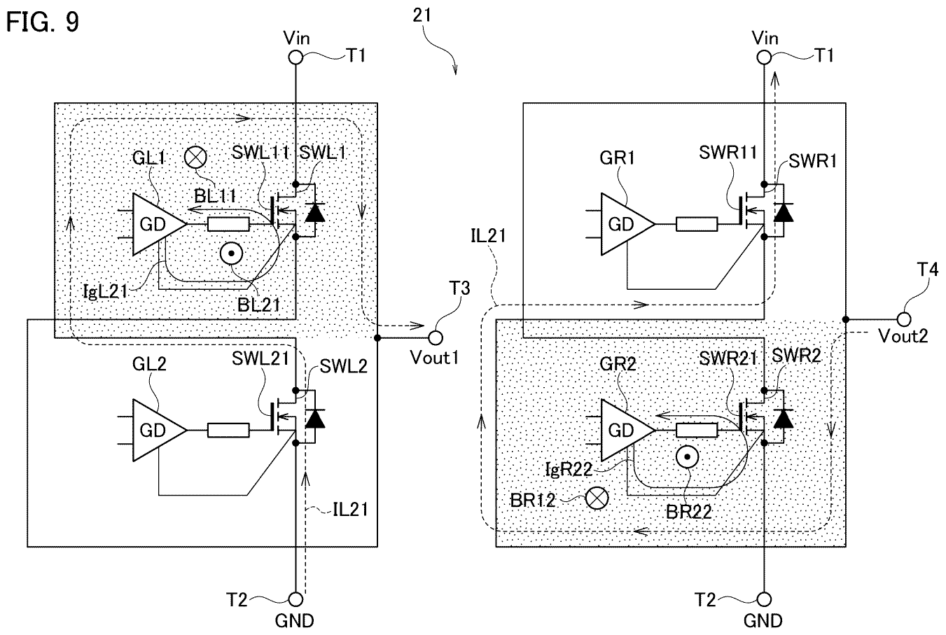

FIG. 8 is an electric circuit diagram of a power conversion circuit 21 according to a third embodiment. The power conversion circuit 21 is a full-bridge inverter. Therefore, an inductor La is implemented by an external motor coil corresponding to the load 3 described above, and terminals of the inductor La are connected to output terminals T3, T4. Output voltages Vout1, Vout2 that are periodically switched are output to the output terminals T3, T4.

Due to the power conversion circuit 21 being a full-bridge inverter, switching elements SWL1, SWL2 which are connected in series with each other in a left leg, and switching elements SWR1, SWR2 which are connected in series with each other in a right leg, are disposed between power supply input terminals T1, T2, the switching elements SWL1, SWR1 of left and right legs being on a high side and the switching elements SWL2, SWR2 of left and right legs being on a low side. The high-side switching elements SWL1, SWR1 of left and right legs and the low-side switching elements SWL2, SWR2 perform complementary switching operations, and left and right legs perform complementary switching operations.

Similar to FIGS. 1 and 6, FIG. 8 illustrates both a state in which the switching elements SWL1, SWR2 are turned on and a conduction current IL11 flows, and a state in which a state of each of the switching elements SWL1, SWR2 changes from a turn-on state to a turn-off state, and a rectified current IL21 flows. At this time, the switching elements SWL2, SWR1 are turned off. Similar to FIGS. 4 and 6, FIG. 9 is a circuit diagram illustrating an extracted portion of the power conversion circuit 21 schematically illustrated in FIG. 8 in a form closer to a substrate mounting state.

When the switching elements SWL1, SWR2 are turned on by gate drivers GL1, GR2, the conduction current IL11 flows as illustrated in FIG. 8. At this time, when the gate drivers GL1, GR2 try to turn off the switching elements SWL1, SWR2, the rectified current IL21 flows as illustrated in FIG. 8. When the rectified current IL21 flows, as illustrated in FIG. 9, magnetic fluxes BL11, BR12 are generated, and induced currents IgL21, IgR22 flow in order to generate magnetic fluxes BL21, BR22 so as to cancel the magnetic fluxes. Charges accumulated in insulating gates SWL11, SWR21 of the switching elements SWL1, SWR2 which have been turned on are drawn out by the induced currents IgL21, IgR22, and the switching elements SWL1, SWR2 are turned off promptly.

Thereafter, when the switching elements SWL2, SWR1 are turned on by gate drivers GL2, GR1, a conduction current flows along a path opposite to the rectified current IL21 illustrated in FIG. 8. When the gate drivers GL2, GR1 try to turn off the switching elements SWL2, SWR1, a rectified current flows along a path opposite to the conduction current IL11 illustrated in FIG. 8.

In this way, even if the power conversion circuit 21 of the third embodiment is a full-bridge inverter, the power conversion circuit 21 can increase the speed of a turn-off operation without having a separate configuration, as in the power conversion circuits 1 and 11 that are half-bridge converters described above.

### Fourth Embodiment

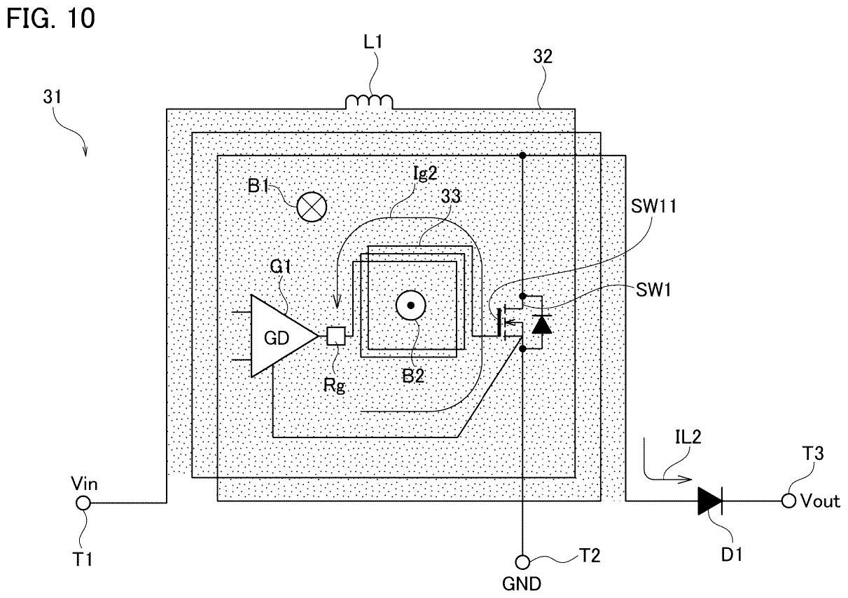

FIG. 10 is a circuit diagram illustrating an extracted portion of a power conversion circuit 31 according to a fourth embodiment in a form closer to a substrate mounting state. The power conversion circuit 31 is a half-bridge non-isolated boost converter similar to the power conversion circuit 1 illustrated in FIGS. 1 and 4, and portions in FIG. 10 corresponding to those in FIGS. 1 and 4 are denoted with the same reference signs. In the power conversion circuit 31, wiring 33 of at least a part of a path from a gate driver G1 to an insulating gate SW11 of one switching element SW1 is arranged along wiring 32 to a high-side switching element D1, that is, wiring through which a rectified current IL2 flows. Specifically, in FIG. 10, the wiring 33 does not connect a gate resistor Rg and the insulating gate SW11 such that the path between the gate resistor Rg and the insulating gate SW11 is the shortest, but the wiring 33 is diverted so as to be close to the wiring 32. As a result, even if a capacitor Cgs or the like is not used, an induced current Ig2 can be obtained and charges accumulated in the insulating gate SW11 can be drawn out rapidly.

Further, in the power conversion circuit 31 of the fourth embodiment, the wiring 32, 33 is wound a plurality of times while intersecting each other on a substrate. Therefore, a magnetic flux B1 generated by the rectified current IL2 increases, a magnetic flux B22 generated by the wiring 33 also increases, and the induced current Ig2 can be made larger.

The power conversion circuit according to the present disclosure can be implemented regardless of whether the circuit is an isolated converter, non-isolated converter, boost converter, buck converter, DC-DC converter, DC-AC converter, or AC-DC converter. More specifically, the power conversion circuits 1, 31 described above are non-isolated DC-DC boost converters, the power conversion circuit 11 is a non-isolated DC-DC buck converter, and the power conversion circuit 21 is an inverter (motor driver). In addition to the above, the power conversion circuit according to the present disclosure can also be implemented by an LLC converter, a phase-shift full-bridge converter, a power factor correction (PFC) circuit, totem-pole bridgeless PFC circuit, or the like. A SiC substrate is used as a substrate of a gate-driven switching element, but the substrate is not limited thereto, and a Si substrate may also be used.

A technical concept that can be apprehended from the present disclosure will be described below. It should be noted that constituent elements described in appendixes are denoted with reference signs of corresponding constituent elements in the embodiments for the purpose of understanding rather than for the purpose of limitation. Reference signs are illustrated as examples for the purpose of understanding, and constituent elements described in each appendix should not be limited to constituent elements indicated by reference signs.

### APPENDIX 1

A power conversion circuit (1, 11, and 31) includes: a high-side switching element and a low-side switching element which are connected in series with each other and perform complementary switching operations, an inductor (L1), and a gate driver (G1). One of the high-side switching element and the low-side switching element is a first switching element (SW1). An insulating gate (SW11) is disposed in the first switching element (SW1). The other of the high-side switching element and the low-side switching element is a second switching element (D1). A first end of the inductor (L1) is connected to a connection point between the first switching element (SW1) and the second switching element (D1). The gate driver (G1) voltage-drives the insulating gate (SW11) of the first switching element (SW1). Due to the first switching element (SW1) being turned on by the gate driver (G1), a conduction current (IL1) flows through the inductor (L1) and energy is stored in the inductor (L1). Further, due to the first switching element (SW1) being turned off by the gate driver (G1), the inductor (L1) releases the energy and a rectified current (IL2) is generated through the second switching element (D1). Accordingly, the power conversion circuit (1, 11, and 31) performs power conversion. A loop of a gate current (Ig1) supplied by the gate driver (G1) to the insulating gate (SW11) of the first switching element (SW1) for driving is formed inside a loop of the rectified current (IL2). A magnetic flux (B2) which is in an opposite direction of a magnetic flux (B1) generated by the rectified current (IL2) and is generated in the loop of the gate current (Ig1) generates an induced current (Ig2) in a direction opposite to the gate current (Ig1).

According to the above configuration, the power conversion circuit has the following features. In the power conversion circuit, the first end of the inductor (L1) is connected to the connection point between the first switching element (SW1) and the second switching element (D1) which are connected in series with each other, and both switching elements (SW1, D1) switch complementarily. That is, by energy storage or energy release performed by the inductor (L1) depending on switching performed by both switching elements (SW1, D1), it is possible to convert power of a DC power supply (2) into desired power and draw out the converted power, or to drive a load (3). As a result, when the first switching element (SW1) is turned on, the conduction current (IL1) flows from the DC power supply (2) to the first switching element (SW1) and the inductor (L1), and when the first switching element (SW1) is turned off, the rectified current (IL2) flows from the inductor (L1) through the second switching element (D1).

When at least the first switching element (SW1) is a voltage-driving element by the insulating gate (SW11) such as an MOSFET and an IGBT, the first switching element (SW1) is turned on and turned off with charges accumulated in the insulating gate (SW11). Then, in the power conversion circuit (1, 11, 31), a current of a predetermined level flows in a path (loop) of the conduction current (IL1) and a path (loop) of the rectified current (IL2), and a magnetic flux (B1) is generated around wiring of the paths (loops).

Therefore, in the present disclosure, the magnetic flux (B1) generated by the rectified current (IL2) is used, and the loop of the gate current (Ig1) is formed inside the loop of the rectified current (IL2). Therefore, the induced current (Ig2) in a direction opposite to the gate current (Ig1) is generated in order to generate the magnetic flux (B2) which is in an opposite direction of the magnetic flux (B1) generated by the rectified current (IL2) so as to cancel the magnetic flux (B1) and is generated in the loop of the gate current (Ig1).

As a result, charges accumulated in the insulating gate (SW11) when the first switching element (SW1) is turned on are drawn out by the induced current (Ig2) that flows from a source (SW12) to the insulating gate (SW11), when the first switching element (SW1) is turned off. In this way, it is possible to realize the power conversion circuit which can increase the speed of a turn-off operation and reduce the switching loss by improving the circuit arrangement without having a separate configuration such as a mirror clamp circuit.

### APPENDIX 2

In the power conversion circuit (1, 11, 31) according to appendix 1, a loop of the induced current (Ig2) is formed by a capacitor (Cgs) disposed for high-frequency connection between a source (SW12) of the first switching element (SW1) and an output terminal of the gate driver (G1).

According to the above configuration, the capacitor (Cgs) is instantaneously short-circuited when the first switching element (SW1) is turned off, and the induced current (Ig2) can be increased. This can draw out charges accumulated in the gate rapidly and increase the speed of a turn-off operation.

### APPENDIX 3

In the power conversion circuit (1, 11, 31) according to appendix 2, a gate coupling capacitance formed between a gate terminal (SW11) and a driver source (SW14) terminal in the first switching element (SW1) is used for the capacitor (Cgs).

According to the above configuration, by using an element with the driver source (SW14) terminal as the first switching element (SW1), the loop of the induced current (Ig2) by short-circuiting in the capacitor (Cgs) is already formed. Therefore, by simply forming the loop of the rectified current (IL2) so as to surround the first switching element (SW1) without providing any special components, it is possible to easily realize the power conversion circuit which can draw out charges accumulated in the gate rapidly and increase the speed of a turn-off operation.

### APPENDIX 4

In the power conversion circuit (31) according to appendix 1, at least a part of a path (33) from the gate driver (G1) to the insulating gate (SW11) of the first switching element (SW1) is arranged along the loop (32) of the rectified current (IL2).

According to the above configuration, even if a capacitor (Cgs) or the like is not used, the induced current (Ig2) can be obtained and charges accumulated in the insulating gate (SW11) can be drawn out rapidly.

### APPENDIX 5

In the power conversion circuit (31) according to appendix 4, at least a part of the path (33) from the gate driver (G1) to the insulating gate (SW11) of the first switching element (SW1) is wound a plurality of times in the loop (32) of the rectified current (IL2).

According to the above configuration, the induced current (Ig2) can be made larger by winding a part of the path (33) a plurality of times while intersecting on a substrate.

### APPENDIX 6

In the power conversion circuit (31) according to appendix 4 or 5, the loop (32) of the rectified current (IL2) is wound a plurality of times.

According to the above configuration, by winding the loop (32) of the rectified current (IL2) a plurality of times while intersecting on a substrate, a magnetic flux B1 generated by the rectified current (IL2) increases, and the induced current (Ig2) can be further increased.

### APPENDIX 7

In the power conversion circuit (1, 11, 31) according to any one of appendixes 1 to 6, the first switching element (SW1) is a SiCMOSFET.

According to the above configuration, a SiCMOSFET is used for applications of high withstand voltage and a large current, and has a large risk of breakdown due to overshoot of a drain-source voltage Vds, and a large switching loss. When the overshoot of the drain-source voltage Vds is tried to be suppressed, it is necessary to increase a gate resistor (Rg), but this slows down a turn-off operation.

Therefore, by applying the present disclosure to this kind of SiCMOSFET, while keeping the gate resistor (Rg), that is, the drain-source voltage Vds without any changes, charges accumulated in the gate can be drawn out rapidly, and the speed of a turn-off operation can be increased.

### APPENDIX 8

In the power conversion circuit (1, 31) according to any one of appendixes 1 to 6, a second end of the inductor (L1) serves as a power supply input terminal (T1), and the power conversion circuit is a half-bridge non-isolated boost converter that draws out desired power from a smoothing capacitor (C2) connected in parallel to the first switching element (SW1) and the second switching element (D1) which are connected in series with each other.

According to the above configuration, the half-bridge non-isolated boost converter has a simple current path (loop). Therefore, it is easy and suitable to form wiring of a path (loop) of the induced current (Ig2) inside wiring of a path (loop) of the rectified current (IL2) and to form the wiring of the paths (loops) such that currents flow in mutually opposite directions in the paths.

### APPENDIX 9

In the power conversion circuit (11) according to any one of appendixes 1 to 6, the first switching element (SW1) and the second switching element (D1) are connected to a power supply (2) and the power conversion circuit is a half-bridge non-isolated buck converter that draws out desired power from a smoothing capacitor (C2) connected to a second end of the inductor (L1).

According to the above configuration, the half-bridge non-isolated buck converter has a simple current path (loop). Therefore, it is easy and suitable to form wiring of a path (loop) of the induced current (Ig2) inside wiring of a path (loop) of the rectified current (IL2) and to form the wiring of the paths (loops) such that currents flow in mutually opposite directions in the paths.

1. A power conversion circuit, comprising:
a high-side switching element and a low-side switching element that are connected in series with each other and perform complementary switching operations;
a first switching element that is one of the high-side switching element and the low-side switching element;
an insulating gate disposed in the first switching element;
a second switching element that is the other of the high-side switching element and the low-side switching element;
an inductor of which a first end is connected to a connection point between the first switching element and the second switching element; and
a gate driver that voltage-drives the insulating gate, wherein
due to the first switching element being turned on by the gate driver, a conduction current flows through the inductor and energy is stored in the inductor, and due to the first switching element being turned off by the gate driver, the inductor releases the energy and a rectified current is generated through the second switching element, so that the power conversion circuit performs power conversion,
a loop of a gate current supplied by the gate driver to the insulating gate of the first switching element for driving is formed inside a loop of the rectified current, and
a magnetic flux that is in an opposite direction of a magnetic flux generated by the rectified current and is generated in the loop of the gate current generates an induced current in a direction opposite to the gate current.

2. The power conversion circuit according to claim 1, further comprising:
a capacitor for high-frequency connection between a source terminal of the first switching element and an output terminal of the gate driver, wherein
a loop of the induced current is formed by the capacitor.

3. The power conversion circuit according to claim 2, wherein
the capacitor is a gate coupling capacitance formed between a gate terminal and a driver source terminal in the first switching element.

4. The power conversion circuit according to claim 1, wherein
at least a part of a path from the gate driver to the insulating gate of the first switching element is arranged along the loop of the rectified current.

5. The power conversion circuit according to claim 4, wherein
at least a part of the path from the gate driver to the insulating gate of the first switching element is wound a plurality of times in the loop of the rectified current.

6. The power conversion circuit according to claim 5, wherein
the loop of the rectified current is wound a plurality of times.

7. The power conversion circuit according to claim 1, wherein
the first switching element is a SiCMOSFET.

8. The power conversion circuit according to claim 1, wherein
a second end of the inductor serves as a power supply input terminal, and the power conversion circuit is a half-bridge non-isolated boost converter that draws out desired power from a smoothing capacitor connected in parallel to the first switching element and the second switching element which are connected in series with each other.

9. The power conversion circuit according to claim 1, wherein
the first switching element and the second switching element are connected to a power supply, and the power conversion circuit is a half-bridge non-isolated buck converter that draws out desired power from a smoothing capacitor connected to a second end of the inductor
